(19) United States
(12) Patent Application Publication
(10) Pub. No.: US 2026/0110346 A1
(43) Pub. Date: Apr. 23, 2026

(54) ABSORBER

(71) Applicants: Tusas- Turk Havacilik Ve Uzay Sanayii Anonim Sirketi, Kahramankazan, Ankara (TR); Gazi Üniversitesi, Ankara (TR)

(72) Inventors: Cebrail CUDRI, Kahramankazan, Ankara (TR); Hudayim BASAK, Yenimahalle, Ankara (TR)

(73) Assignees: Tusas- Turk Havacilik Ve Uzay Sanayii Anonim Sirketi, Kahramankazan, Ankara (TR); Gazi Üniversitesi, Ankara (TR)

(21) Appl. No.: 19/117,049

(22) PCT Filed: Sep. 27, 2023
(86) PCT No.: PCT/TR2023/051040

§ 371 Date: Mar. 30, 2025

(30) Foreign Application Priority Data
Sep. 30, 2022 (TR) 2022/015005

(51) Int. Cl. F16F 7/08; B64C 25/32; B64C 25/64

(52) U.S. Cl. CPC F16F 7/087; B64C 25/64; B64C 2025/325; F16F 2222/04; F16F 2224/02; F16F 2226/04

(57) ABSTRACT

The present invention relates to a body (B); at least a first piece (2) located on the body (B); at least a second piece (3) positioned opposite the first piece (2); a plurality of extensions (201) made of a flexible material, located on the first piece (2) and second piece (3), and extending from the first piece (2) to the second piece (3) and from the second piece (3) to the first piece (2).

This invention relates to an absorber developed to protect equipment and/or a body of a living creature from the forces occurring on the body.

In important situations, such as protecting the equipment placed on the body against incoming forces or the health of an athlete in sports branches containing application of force, the person must be protected. There are absorbers which, in case of an impact, enable the protection of devices or systems used in aviation and space fields, protective helmets or sensitive devices used in mechanical systems. The concern of creating a load while protecting or absorbing the incoming forces is important for manufacturers and/or users.

US20190232601A1, which is included in the known-state of the art, discloses a protective material/structure based on a structure in which an inner and outer shell can move relative to each other, and which reduces the risk of injury to a person after contact.

US2018206580A1, which is included in the known-state of the art, discloses an impact protection device. The impact protection device comprises a support surface, a first plurality of flexible spines and a second plurality of flexible spines.

Thanks to an absorber according to the present invention, the loads are absorbed by preventing the loads on the body from damaging the body, and undesirable effects created on the equipment provided on the body, such as impact and vibration, are absorbed, so that the protection is provided.

Another object of the present invention is to obtain an absorbing system that provides protection through the absorber, by absorbing the loads occurring on the body mounted on an air vehicle. With the absorber, an absorbing system is obtained that protects the body and extends the maintenance period of the body, by absorbing the loads caused by the contact of the landing gear of the air vehicle with the ground.

An absorber realized to achieve the object of the invention, which is defined in the first claim and other claims dependent thereon, comprises at least a first piece located on a body (B).

Any surfaces of the first piece and the second piece are positioned opposite each other, corresponding to each other. Multiple extensions made of a flexible material are provided on the first piece and the second piece, which extend from the first piece to the second piece and from the second piece to the first piece. The extensions can extend on the first piece and the second piece at the same angle or inclination.

In the absorber according to the invention, a third piece and a fourth piece are provided on the body, between the first piece and the second piece, so as to be opposite each other and form a box form with the first piece and the second piece. It comprises a plurality of protrusions made of a flexible material, which are located on the third piece and the fourth piece and absorb the forces on the body by engaging with the extensions or interposing between the extensions. The protrusions may be located at the same angle or inclination on the third piece and the fourth piece, or preferably, the protrusions may be located almost completely at 60 degrees on the third piece, while being located on the fourth piece at different angles to each other, such as almost completely −60 degrees.

In an embodiment of the invention, the absorber comprises protrusions located on the third piece and fourth piece, diagonally between the extensions towards the first piece or the second piece.

In an embodiment of the invention, the absorber comprises a form in which the third piece and the fourth piece will form a whole on the first piece and the second piece, due to the incoming loads. While the third piece and the fourth piece are placed on the first piece and the second piece, they are positioned on the first piece and the second piece by contacting a groove that extends longitudinally along the length of the pieces. While the third piece and the fourth piece are placed on the first piece and the second piece, the protrusions are almost completely interposed between the extensions, and the movement of the third piece and/or the fourth piece is stopped thanks to the contact of the third piece and the fourth piece with the grooves on the first piece and the second piece.

In an embodiment of the invention, the absorber comprises that the first piece, the second piece, the third piece and the fourth piece can be integrated into a box-shaped body, while being placed in the first mounting apparatus in a removable manner. The first piece, second piece, third piece and fourth piece placed in the first mounting apparatus can be replaced by the user as desired.

In an embodiment of the invention, the absorber comprises at least one landing gear on a body of an air vehicle, which contacts the ground (runway) during landing of the air vehicle to carry the air vehicle and/or allows the air vehicle to move on the ground. In order to absorb the reaction forces that occur when the air vehicle contacts the runway or the situations that affect the strength of the landing gear, the absorber is placed in the first mounting apparatus, and a second mounting apparatus is removably attached to the “skid” landing gear to move as a female-male connection within the first mounting apparatus. The second mounting apparatus is produced in “U” form.

In an embodiment of the invention, the absorber comprises extensions and protrusions that are made of polymer materials such as thermoplastic or rubber. Therefore, the incoming forces can be absorbed or the absorbing threshold is increased.

In an embodiment of the invention, the absorber comprises extension and/or protrusion that are produced by three-dimensional printing or any of the additive manufacturing methods. In this way, flexible and/or highly durable production is achieved.

In an embodiment of the invention, the absorber comprises a plurality of extensions extending from the first piece to the second piece and from the second piece to the first piece, with a narrowing cross-sectional area or a pointed tip in the form of a “hedgehog spine”.

In an embodiment of the invention, the absorber comprises a plurality of protrusions extending from the third piece to the first piece or the second piece and from the fourth piece to the first piece or the second piece, with a narrowing cross-sectional area or a pointed tip in the form of a “hedgehog spine”.

In an embodiment of the invention, the absorber comprises protrusions which push the extensions between the extensions or contact each other respectively in a “domino effect”, when a force is applied to the third piece or the fourth piece, so that the force is absorbed.

The absorber realized to achieve the object of the present invention is illustrated in the attached drawings, in which:

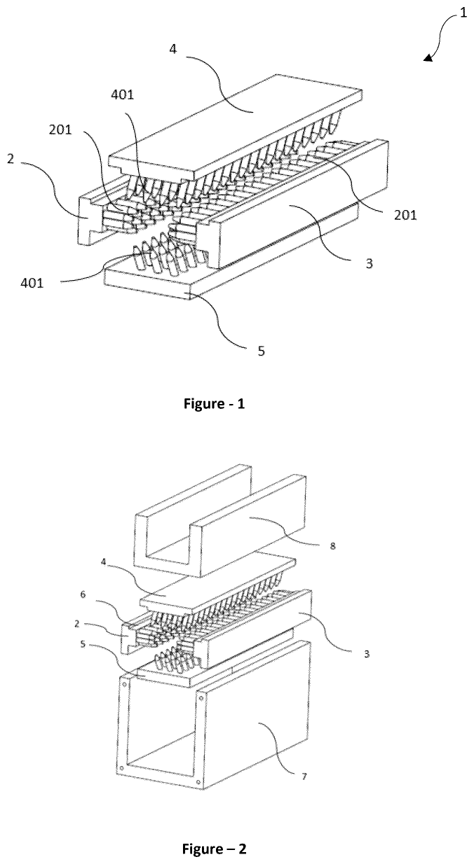

FIG. 1 is a perspective view of the absorber.

FIG. 2 is an exploded view of the absorber.

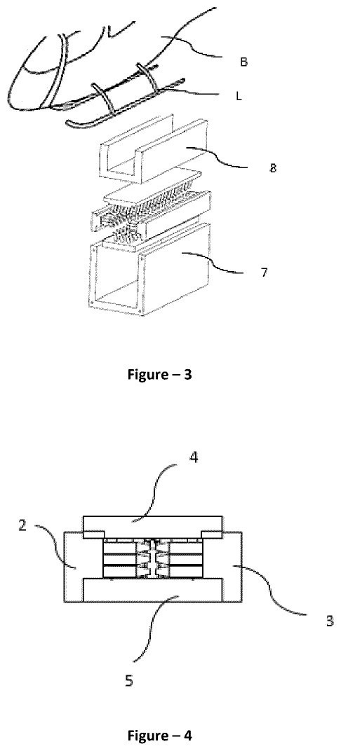

FIG. 3 is an exploded view of the absorber on the body.

FIG. 4 is a side view illustrating the protrusions between the extensions.

All the parts illustrated in figures are individually assigned a reference numeral and the corresponding terms of these numbers are listed below:
1. Absorber
2. First Piece
201. Extension
3. Second Piece
4. Third Piece
401. Protrusion
5. Fourth Piece
6. Groove
7. First Mounting Apparatus
8. Second Mounting Apparatus
(G) Body
(L) Landing Gear

The absorber (1) comprises a body (B); at least a first piece (2) located on the body (B); at least a second piece (3) positioned opposite the first piece (2); a plurality of extensions (201) made of a flexible material, located on the first piece (2) and second piece (3), and extending from the first piece (2) to the second piece (3) and from the second piece (3) to the first piece (2).

The absorber (1) according to the invention comprises at least a third piece (4) located on the body (B), between the first piece (2) and the second piece (3); a fourth piece (5) located on the body (B), between the first piece (2) and the second piece (2), so as to be opposite the third piece (4); a plurality of protrusions (401) made of a flexible material and located on the third piece (4) and fourth piece (5), wherein the protrusions (401) are interposed between the extensions (201) so as to absorb the forces occurring on the body (B).

There is a body (B) containing the air vehicle, equipment or a mechanism; and at least a first piece (2) located on the body (B). A second piece (3) is positioned opposite the first piece (2), at a distance therebetween. A plurality of extensions (201) made of a flexible material suitable for elastic deformation are located on the first piece (2) and the second piece (3), extending from the first piece (2) to the second piece (3) and from the second piece (3) to the first piece (2). Extensions (201) reduce the pressure by absorbing the loads occurring on the body (B) or on the first piece (2) or the second piece (3).

A third piece (4) is located on the body (B), between the first piece (2) and the second piece (3), at an equal distance from the first piece (2) and the second piece (3). A fourth piece (5) is located on the body (B) so as to be opposite the third piece (4), and to form a box-form between the first piece (2) and the second piece (3) together with the third piece (4). A plurality of protrusions (401) made of a flexible material is provided on the third piece (4) and the fourth piece (5), which is at least partially interposed between the extensions (201) and/or almost completely interposed between the extensions (201) thanks to the incoming force. The protrusions (401) are interposed between the extensions (201) with the incoming loads and almost completely reduce the pressure, so that service life of the body (B) is prolonged and the systems on the body (B) are prevented from being damaged (FIG. 1, FIG. 4).

In an embodiment of the invention, the absorber (1) comprises a plurality of protrusions (401) extending from the third piece (4) and the fourth piece (5) towards the first piece (2) or the second piece (3). Since the protrusions (401) are located diagonally between the extensions (201), they almost completely absorb the pressure coming from all directions or occurring in all directions.

In an embodiment of the invention, the absorber (1) comprises at least one groove (6) which extends longitudinally along the first piece (2) and second piece (3), and allows the third piece (4) and fourth piece (5) to be placed on the first piece (2) and second piece (3) thanks to the incoming loads. The third piece (4) and the fourth piece (5) are placed in the groove (6) located on the first piece (2) and the second piece (3), thanks to the incoming loads. Therefore, it acts as a stopper allowing the protrusions (401) to move to a certain point between the extensions (201), and absorbs the incoming load as a whole.

In an embodiment of the invention, the absorber (1) comprises at least a first mounting apparatus (7) which enables the removable placement of the first piece (2), second piece (3), third piece (4) and fourth piece (5), and at least partially surrounds the pieces. Thanks to the first mounting apparatus (7), the first piece (2), the second piece (3), the third piece (4) and the fourth piece (5) are placed in the first mounting apparatus (7) and removably attached to an area to be protected from loads (FIG. 2).

In an embodiment of the invention, the absorber (1) comprises a body (B), which is an air vehicle; at least one landing gear (L) on the body (B), which contacts the ground (runway) during landing of the air vehicle (H) to carry the air vehicle and/or allows the air vehicle to move on the ground; a second mounting apparatus (8) removably attached to the landing gear (L), produced in “U” form, and moving in the first mounting apparatus (7). The second mounting apparatus (8) is attached removably in a form compatible manner with the landing gear (L) of the air vehicle, which is a helicopter. The loads generated by the contact of the air vehicle (H) with the runway are transmitted to the first piece (2), second piece (3), third piece (4) and fourth piece (5) that are located in the first mounting apparatus (7), so that the loads on the landing gear (L) are absorbed (FIG. 2, FIG. 3).

In an embodiment of the invention, the absorber (1) comprises the extension (201) and the protrusion (401) which are made of a polymer material and increase an absorbing threshold. Thanks to the extension (201) and protrusion (401) made of a polymer material, flexible extensions (201) and protrusions (401) with an improved absorbing capability are obtained. In an embodiment of the invention, the absorber (1) comprises extension (201) and/or protrusion (401) produced by an additive manufacturing method, thereby being flexible and/or highly durable. With the additive manufacturing method, the extension (201) and protrusion (401) can be produced easily, in a design determined by the user or manufacturer.

In an embodiment of the invention, the absorber (1) comprises the extension (201) extending from the first piece (2) to the second piece (3) and from the second piece (3) to the first piece, with a narrowing cross-sectional area. The narrowing cross-sectional area of the extensions (201) enables the extensions to bend under a load, from the pointed tip to the other, wider tip, thereby improving the absorbing.

In an embodiment of the invention, the absorber (1) comprises the protrusion (401) extending from the third piece (4) to the first piece (2) or the second piece (3) and from the fourth piece (5) to the first piece (2) or the second piece (3), with a narrowing cross-sectional area. The narrowing cross-sectional area of the protrusions (401) enables them to be interposed between the extensions (201) easily, and to bend under a load, from the pointed tip to the other, wider tip, thereby improving the absorbing.

In an embodiment of the invention, the absorber (1) comprises a plurality of protrusions (401) interposed sequentially between the extensions (201) in a “domino effect”, when a force is applied to the third piece (4) or the fourth piece (5). As the protrusions (401) are interposed between the extensions (201), they push the plurality of extensions (201), causing them to bend and improve the absorbing.

1. An absorber (1) comprising a body (B); at least a first piece (2) located on the body (B); at least a second piece (3) positioned opposite the first piece (2); a plurality of extensions (201) made of a flexible material, located on the first piece (2) and second piece (3), and extending from the first piece (2) to the second piece (3) and from the second piece (3) to the first piece (2), wherein at least a third piece (4) located on the body (B), between the first piece (2) and the second piece (3); a fourth piece (5) located on the body (B), between the first piece (2) and the second piece (2), so as to be opposite the third piece (4), first part (2), second part (3) and third part (4) facing each other to form a box; a plurality of protrusions (401) made of a flexible material and located on the third piece (4) and fourth piece (5), wherein the protrusions (401) are positioned located diagonally between adjacent extensions (201) such that they engaged therewith under load, absorb the forces occurring on the body (B).

2. An absorber (1) according to claim 1, wherein plurality of protrusions (401) extending from the third piece (4) and the fourth piece (5) towards the first piece (2) or the second piece (3).

3. An absorber (1) according to claim 1, wherein at least one groove (6) which extends longitudinally along the first piece (2) and second piece (3), and allows the third piece (4) and fourth piece (5) to be placed on the first piece (2) and second piece (3) thanks to the incoming loads.

4. An absorber (1) according to claim 1, wherein at least a first mounting apparatus (7) which enables the removable placement of the first piece (2), second piece (3), third piece (4) and fourth piece (5), and at least partially surrounds the pieces.

5. An absorber (1) according to claim 1, wherein a body (B), which is an air vehicle; at least one landing gear (L) on the body (B), which contacts the ground (runway) during landing of the air vehicle (H) to carry the air vehicle and/or allows the air vehicle to move on the ground; a second mounting apparatus (8) removably attached to the landing gear (L), produced in “U” form, and moving in the first mounting apparatus (7).

6. An absorber (1) according to claim 1, wherein the extension (201) and the protrusion (401) which are made of a polymer material and increase an absorbing threshold.

7. An absorber (1) according to claim 1, wherein the extension (201) and/or protrusion (401) produced by an additive manufacturing method, thereby being flexible and/or highly durable.

8. An absorber (1) according to claim 1, wherein the extension (201) extending from the first piece (2) to the second piece (3) and from the second piece (3) to the first piece, with a narrowing cross-sectional area.

9. An absorber (1) according to claim 1, wherein the protrusion (401) extending from the third piece (4) to the first piece (2) or the second piece (3) and from the fourth piece (5) to the first piece (2) or the second piece (3), with a narrowing cross-sectional area.

10. An absorber (1) according to claim 1, claims, wherein a plurality of protrusions (401) interposed sequentially between the extensions (201) in a “domino effect”, when a force is applied to the third piece (4) or the fourth piece (5).
